(19) United States
(12) Patent Application Publication
(10) Pub. No.: US 2024/0239387 A1
(43) Pub. Date: Jul. 18, 2024

(54) TRAIN POSITIONING METHOD AND POSITIONING SYSTEM

(71) Applicant: BYD COMPANY LIMITED, SHENZHEN (CN)

(72) Inventors: Qiongfang WANG, Shenzhen (CN); Chujun CHEN, Shenzhen (CN); Yedi XIAO, Shenzhen (CN)

(21) Appl. No.: 18/622,288

(22) Filed: Mar. 29, 2024

Related U.S. Application Data
(63) Continuation of application No. PCT/CN2022/133771, filed on Nov. 23, 2022.

(30) Foreign Application Priority Data
Nov. 30, 2021 (CN) 202111443539.0

(51) Int. Cl. B61L 25/02; H04B 17/318

(52) U.S. Cl. CPC B61L 25/028; B61L 25/021; H04B 17/318

(57) ABSTRACT

A method for train positioning includes: periodically transmitting, by a balise transmission module (BTM), balise data to a vehicle on-board controller (VOBC) according to a rule; periodically receiving, by the VOBC, the balise data transmitted by the BTM, and periodically obtaining a data frame, the data frame comprising a current traveling time tn, a current traveling speed vn, and a current traveling distance sn of a train; and determining, by the VOBC based on the received balise data and the obtained data frame, a location of the train when the train passes a balise.

### CROSS-REFERENCE TO RELATED APPLICATIONS

The application is a continuation application of International Patent Application No. PCT/CN2022/133771 filed on Nov. 23, 2022, which is based on and claims priority to and benefits of Chinese Patent Application 202111443539.0, filed on Nov. 30, 2021. The entire content of all of the above-referenced applications is incorporated herein by reference.

### FIELD

The present disclosure relates to the field of transportation technologies, and more particularly, to a train positioning method and a train positioning system.

### BACKGROUND

Trains such as a subway and a high-speed rail are used as travel tools. To ensure orderly operation of the trains, it is particularly important to position the train. The key to positioning the train is to determine a location of the train when the train passes a central point of a balise.

A balise transmission module (BTM) on the train usually needs to rely on data transmitted by a vehicle on-board controller (VOBC) during calculation of the location of the train when the train passes the balise. However, if the data transmitted by the VOBC is disturbed, causing a failure to calculate the central point by the BTM, the BTM may not correctly feedback the balise information. The VOBC may trigger emergency braking or the positioning accuracy is reduced due to a loss of the balise information, which ultimately leads to an increase in a train failure rate, and may also affect train parking accuracy and reduce the applicability.

### SUMMARY

In view of the foregoing defects or disadvantages in the related art, the present disclosure provides a train positioning method and a train positioning system.

According to a first aspect, a method for train positioning includes: periodically transmitting, by a balise transmission module (BTM), balise data to a vehicle on-board controller (VOBC) according to a rule; periodically receiving, by the VOBC, the balise data transmitted by the BTM, and periodically obtaining a data frame, the data frame comprising a current traveling time tn, a current traveling speed vn, and a current traveling distance sn of a train; and determining, by the VOBC based on the received balise data and the obtained data frame, a location of the train when the train passes a balise.

According to a second aspect, a system for train positioning includes: a BTM and a VOBC.

The BTM is configured to periodically transmit balise data to the VOBC according to a rule. The balise data includes identification information of a balise.

The VOBC is configured to periodically receive the balise data transmitted by the BTM, and periodically obtain a data frame. The data frame includes a current traveling time tn, a current traveling speed vn, and a current traveling distance sn of a train.

The VOBC is configured to determine, based on the received balise data and the obtained data frame, a location of the train when the train passes the balise.

According to a third aspect, a vehicle on-board device is provided, including: one or more processors and a memory.

The memory is configured to store one or more programs.

When the one or more programs are executed by the one or more processors, the one or more processors are configured to perform the method for train positioning provided in various embodiments of the present disclosure.

According to a fourth aspect, a non-transitory computer-readable storage medium storing a computer program is provided. When the program is executed by a processor, the method for train positioning provided in various embodiments of the present disclosure is implemented.

According to the technical solution provided in the embodiments of the present disclosure, the VOBC does not need to transmit any information to the BTM during the calculation of the location of the train when the train passes the balise (e.g., the central point of the balise). The BTM periodically transmits the balise data to the VOBC according to the preset rule. The VOBC calculates the time t_balise when the train passes the balise based on the recorded time difference (a time difference between a receiving time of the balise data and an obtaining time of the data frame of train traveling information). Further, the location of the train when the train passes the balise is calculated based on the time t_balise when the train passes the balise and the list of saved train traveling information, and then the train location is accurately calibrated, so that a probability of data loss is small and train positioning accuracy is high.

### BRIEF DESCRIPTION OF THE DRAWINGS

The features, objects, and advantages of the present disclosure become more apparent by the detailed description of the embodiments with reference to the following accompanying drawings.

FIG. 1 is a flow block diagram of a train positioning method provided in the related art.

FIG. 2 is a flow block diagram of a train positioning method according to an embodiment of the present disclosure.

FIG. 3 is a schematic diagram of calculation of a central point of an American standard balise according to an embodiment of the present disclosure.

FIG. 4 is a structural diagram of a train positioning system according to an embodiment of the present disclosure.

FIG. 5 is a schematic structural diagram of a vehicle on-board device according to an embodiment of the present disclosure.

### DETAILED DESCRIPTION

For a person skilled in the art to better under the solutions of the present disclosure, the following clearly describes the technical solutions in embodiments of the present disclosure with reference to the accompanying drawings in the embodiments of the present disclosure. Apparently, the described embodiments are merely some rather than all of the embodiments of the present disclosure. The embodiments obtained by a person of ordinary skill in the art based on the embodiments of the present disclosure without creative efforts shall fall within the protection scope of the present disclosure.

It should be noted that, the embodiments in the present disclosure and features in the embodiments may be combined with each other in a case that no conflict occurs. The present disclosure is described in detail below with reference to the accompanying drawings and the embodiments.

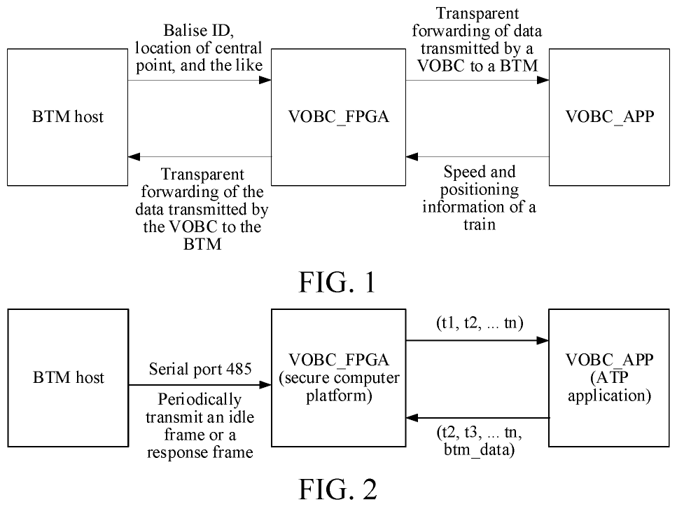

When an existing balise calculates positioning information of a train passing a central point of a balise by using a balise transmission module (BTM) terminal, speed and positioning information needs to be periodically transmitted to the BTM by relying on automatic train protection (ATP) in a vehicle on-board controller (VOBC). The BTM calculates the location of the balise based on the positioning information of the ATP, but the following defects may exist. As shown in FIG. 1, the VOBC includes a field programmable gate array (FPGA) terminal and an application (APP) terminal. A BTM may rely on data such as the train speed and positioning information transmitted by the VOBC to calculate the location of the balise. If the transmission data is disturbed and the calculation of the central point fails, the BTM may not correctly feedback the balise information. The ATP may trigger emergency braking or the positioning accuracy is reduced due to a loss of the balise information, which ultimately leads to an increase in a train failure rate, and may also affect train parking accuracy and reduce the applicability.

Referring to FIG. 2, FIG. 2 shows a train positioning method according to an embodiment of the present disclosure. The method includes the following steps.

S10: A BTM periodically transmits balise data to a VOBC according to a preset rule. The balise data includes identification information of a balise.

S20: The VOBC periodically receives the balise data transmitted by the BTM, and periodically obtains a data frame. The data frame includes a current traveling time tn, a current traveling speed vn, and a current traveling distance sn of a train. n is a quantity of obtaining cycles of the data frame.

S30: The VOBC determines, based on the received balise data and the obtained data frame, a location of the train when the train passes the balise (e.g., the central point of the balise).

In an embodiment, in the train positioning method provided in this embodiment, the VOBC does not need to transmit any information to the BTM during calculation of the location of the train when the train passes the balise. When interference occurs on a serial link, the calculation of the central point and receiving of the balise data may not be affected. Software and protocols have strong anti-interference capabilities, thereby improving applicability. In the related art, the VOBC is required to transmit information such as a speed and a location of a train to the BTM during calculation of the location of the train when the train passes the balise.

In this embodiment of the present disclosure, the BTM periodically transmits the balise data to the VOBC according to the preset rule. The balise data is periodically and continuously transmitted from a BTM to the VOBC without a request from the VOBC. In the related art, the BTM reply with the balise data only when receiving a request from the VOBC. In the related art, it is required that both receiving and transmitting be performed correctly, and the probability of data loss increases when interference occurs.

In this embodiment of the present disclosure, a calculation algorithm for the location of the train when the train passes the balise is calculated by the VOBC, which may perform more accurate and detailed calculation based on a real-time speed of the train, improve positioning accuracy, and improve flexibility of the algorithm.

In an embodiment, step S10 includes the following sub-steps.

S101: An idle frame is periodically transmitted to the VOBC if the BTM has not detected the balise.

S102: A response frame is periodically transmitted to the VOBC if the BTM has detected the balise. The response frame includes identification information and an energy mark parameter of the balise.

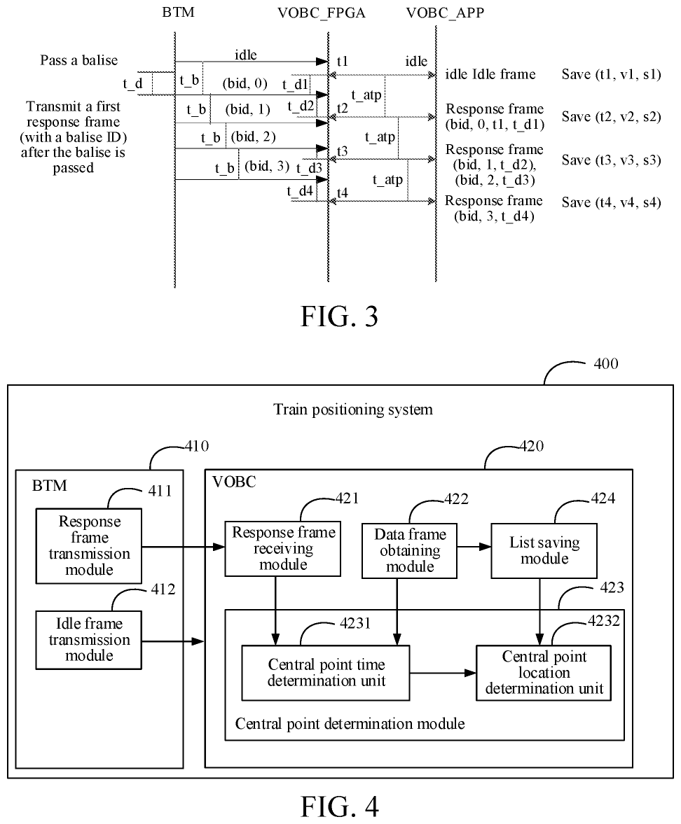

In this embodiment, as shown in FIG. 3, the BTM periodically transmits the balise data to the VOBC. An interval t_b at which the BTM (e.g., the BTM host) transmits the balise data to the VOBC (an equal interval for each transmission) is 50 ms. For example, t_b is a transmission cycle of the response frame. The idle frame is transmitted to the VOBC when a receiving antenna of the BTM has not detected the balise. In FIG. 3, Idle represents the idle frame. When the balise is detected, the response frame is transmitted. ID information of the balise is carried in the response frame. In FIG. 3, in (bid, 0), (bid, 1), . . . bid is the balise ID, and a second natural number (e.g., 0, 1, . . . ) is the energy mark parameter. Based on a change of detected signal energy or signal strength of the balise, different energy mark parameters are transmitted to the VOBC.

In an embodiment, S102 includes the following sub-steps.

Before the signal energy or signal strength detected by the BTM reaches a peak value, among the response frames periodically transmitted to the VOBC, the energy mark parameter is a preset mark value. When the signal energy of the balise detected by the BTM reaches the peak value, the location of the train when the train passes the balise is determined.

After the signal strength detected by the BTM reaches a peak value, among the response frames periodically transmitted to the VOBC, the energy mark parameter is successively increased or decreased based on a preset interval ω as the number of transmission cycles of the response frame increases.

It should be noted that, the detected signal strength by the BTM is related to a distance between the BTM and the balise. A smaller distance between the BTM and the balise leads to greater signal energy of the detected balise. However, in the entire process of the train passing the balise, the distance between the BTM and the balise changes from far to near. When the BTM is located on the balise, the distance between the BTM and the balise is the closest, and then the BTM gradually moves away from the balise. Therefore, when the signal energy of the balise detected by the BTM reaches the peak value, the location of the train when the train passes the balise is determined.

In this embodiment, the BTM transmits different energy mark parameters to the VOBC based on the change of the signal energy of the detected balise. For example, before the signal energy of the detected balise reaches the peak value, the energy mark parameter transmitted to the VOBC may be a preset mark value (such as −1), and after the signal energy of the detected balise reaches the peak value, the energy mark parameter in the response frame may be increased successively based on the preset interval co on the basis of the preset mark value. For example, the energy mark parameter in the response frame transmitted to the VOBC is increased by 1 before transmission, and for each transmission, the energy mark parameter is increased by 1. For example, as the number of the transmission cycles of the response frame increases, the energy mark parameter in the response frame is increased successively to 0, 1, 2, 3, . . . (as shown in FIG. 3, the preset interval is 1 in this case). The energy mark parameter of 0 represents an energy mark parameter in a first response frame transmitted by the BTM to the VOBC after the train passes the location of the balise. The energy mark parameter that is greater than or equal to 0 represents that the train has passed the location of the balise. For another example, as the number of the transmission cycles of the response frame increases, the energy mark parameter in the response frame is increased successively to 0, 2, 4, 6, . . . . In this case, the preset interval is 2.

In an embodiment, when the detected signal strength reaches the peak value, the energy mark parameter in the response frame may be reduced successively based on the preset interval on the basis of the preset mark value. For example, the preset mark value is 10. After the signal energy of the balise reaches the peak value, as the number of the transmission cycles of the response frame increases, the energy mark parameter in the response frame is decreased successively to 8, 6, 4, 2, . . . .

It should be noted that, in this embodiment, an example in which the preset mark values are −1 and 10 is used for description. In a practical application, adjustment may also be made, and the energy mark parameter value after the signal energy of the balise reaches the peak value may be correspondingly adjusted. After the signal energy of the balise received by the BTM reaches the peak value, among the response frames periodically transmitted by the BTM to the VOBC, the energy mark parameter is successively increased or decreased based on the preset interval. A response frame transmission cycle interval m between transmission of the first response frame and transmission of a current response frame by the BTM is determined by using the energy mark parameter in the first response frame transmitted and the energy mark parameter in the current response frame transmitted after the train passes the location of the balise. As shown in FIG. 3, the energy mark parameter of the first response frame is 0. When the energy mark parameter in the current response frame is 3, the response frame transmission cycle interval m between transmission of the current response frame and transmission of the first response frame by the BTM is 3. When the energy mark parameter in the current response frame is 2, m is 2.

In an embodiment, S102 includes the following sub-steps.

Before the signal energy of the balise detected by the BTM reaches the peak value, among the response frames periodically transmitted to the VOBC, the energy mark parameter is successively increased based on the preset interval as the number of transmission cycles of the response frame increases. When the signal energy of the balise detected by the BTM reaches the peak value, the location of the train when the train passes the balise is determined.

After the signal energy of the balise detected by the BTM reaches the peak value, among the response frames periodically transmitted to the VOBC, the energy mark parameter is successively increased or decreased based on the preset interval as the number of transmission cycles of the response frame increases.

In this embodiment, the BTM transmits different energy mark parameters to the VOBC based on the change of the signal energy of the detected balise. For example, before the signal energy of the detected balise reaches the peak value, the energy mark parameter transmitted to the VOBC is increased successively based on the preset interval. For example, as the number of transmission cycles of the response frame increases, the energy mark parameter in the response frame is increased successively to 0, 1, 2, 3, . . . . However, after the signal energy of the detected balise reaches the peak value, the energy mark parameter transmitted to the VOBC is increased successively based on the preset interval. For example, as the number of transmission cycles of the response frame increases, the energy mark parameter in the response frame is increased successively to 15, 16, 17, . . . , where 15 is the energy mark parameter in the first response frame transmitted by the BTM to the VOBC after the train passes the location of the balise.

In an embodiment, before the signal energy of the detected balise reaches the peak value, the energy mark parameter transmitted to the VOBC is increased successively based on the preset interval. For example, as the number of transmission cycles of the response frame increases, the energy mark parameter in the response frame is increased successively to 0, 2, 4, 6, . . . . However, after the signal energy of the detected balise reaches the peak value, the energy mark parameter transmitted to the VOBC is decreased successively based on the preset interval. For example, as the number of transmission cycles of the response frame increases, the energy mark parameter in the response frame is decreased successively to 15, 14, 13, . . . , where 15 is the energy mark parameter in the first response frame transmitted by the BTM to the VOBC after the train passes the location of the balise.

Similarly, after the signal energy of the balise received by the BTM reaches the peak value, among the response frames periodically transmitted by the BTM to the VOBC, the energy mark parameter is increased or decreased successively based on the preset interval. A response frame transmission cycle interval m between transmission of the current response frame and transmission of the first response frame by the BTM can be determined through the change of the energy mark parameters. For example, when the energy mark parameter in the first response frame transmitted by the BTM to the VOBC is 15, the energy mark parameter of the current response frame is 13, and the preset interval is 1, m is 2.

In an embodiment, S102 includes the following sub-steps.

Before the signal energy of the balise detected by the BTM reaches the peak value, among the response frames periodically transmitted to the VOBC, the energy mark parameter is successively increased based on the preset interval as the number of transmission cycles of the response frame increases. When the signal energy of the balise detected by the BTM reaches the peak value, the location of the train when the train passes the balise is determined.

After the signal energy of the balise detected by the BTM reaches the peak value, among the response frames periodically transmitted to the VOBC, the energy mark parameter is successively increased or decreased based on the preset interval as the number of transmission cycles of the response frame increases.

In this embodiment, the BTM transmits different energy mark parameters to the VOBC based on the change of the signal energy of the detected balise. For example, before the signal energy of the detected balise reaches the peak value, the energy mark parameter transmitted to the VOBC is decreased successively based on the preset interval. For example, as the number of transmission cycles of the response frame increases, the energy mark parameter in the response frame is decreased successively to 18, 16, 14, 12, . . . . However, after the signal energy of the detected balise reaches the peak value, the energy mark parameter transmitted to the VOBC is increased successively based on the preset interval. For example, as the number of transmission cycles of the response frame increases, the energy mark parameter in the response frame is increased successively to 8, 9, 10, . . . , where 8 is the energy mark parameter in the first response frame transmitted by the BTM to the VOBC after the train passes the location of the balise.

In an embodiment, before the signal energy of the detected balise reaches the peak value, the energy mark parameter transmitted to the VOBC is decreased successively based on the preset interval. For example, as the number of transmission cycles of the response frame increases, the energy mark parameter in the response frame is decreased successively to 20, 19, 18, 17, . . . . However, after the signal energy of the detected balise reaches the peak value, the energy mark parameter transmitted to the VOBC is decreased successively based on the preset interval. For example, as the number of transmission cycles of the response frame increases, the energy mark parameter in the response frame is decreased successively to 10, 9, 8, . . . , where 10 is the energy mark parameter in the first response frame transmitted by the BTM to the VOBC after the train passes the location of the balise.

Similarly, after the signal energy of the balise received by the BTM reaches the peak value, among the response frames periodically transmitted by the BTM to the VOBC, the energy mark parameter is increased or decreased successively based on the preset interval. The response frame transmission cycle interval m between transmission of the current response frame and transmission of the first response frame by the BTM can be determined through the change of the energy mark parameters.

Therefore, in the present disclosure, before the signal energy of the detected balise reaches the peak value, the energy mark parameter transmitted to the VOBC is decreased or increased successively based on the preset interval or by using multiple implementations such as a preset threshold, which is not limited in the present disclosure. After the signal energy of the detected balise reaches the peak value, the energy mark parameter in the response frame changes according to a rule based on the transmission cycle of the response frame, which is convenient to calculate the response frame transmission cycle interval m=|E_{b}−Eₐ|/ω between transmission of the current response frame and transmission of the first response frame by the BTM after the train passes the location of the balise. E_{b} is the energy mark parameter in the current response frame, Eₐ is the energy mark parameter in the first response frame, and ω is the preset interval.

In step 520, the VOBC periodically obtains the data frame. The data frame includes the current traveling time, the current traveling speed, and the current traveling distance of the train. As shown in FIG. 3, t_atp is a processing cycle of the VOBC, which is 200 ms, that is, an obtaining cycle of the data frame. t1, t2, . . . , and tn are each a current system time (tn=t (n−1)+t_atp) transmitted to the FPGA by the APP terminal in the VOBC every cycle. At the transmission time tn of the VOBC, the system time tn, the current traveling speed vn, and the current accumulated traveling distance sn in this cycle may be saved to the list location_list [n]. location_list [n]={{t1, v1, s1}, {t2, v2, s2}, {t3, v3, s3}, . . . , {tn, vn, sn}}, and a maximum length of the list may be 10. As shown in FIG. 3, location_list [n]={{t1, v1, s1}, {t2, v2, s2}, {t3, v3, s3}, {t4, v4, s4}}. For example, the list length is 4 (e.g., n=4). The list length of the location_list may be increased, and reliability of the algorithm may be improved by increasing space complexity, to enhance the applicability. For example, in the present disclosure, the length of the list may be increased by shortening the processing cycle of the VOBC.

In an embodiment, step S20 may further include the following steps. The VOBC periodically obtains the data frame and saves the obtained data frame to a list location_list [n]. The list location_list[n] includes the current traveling time tn, the current traveling speed vn, and the current traveling distance sn of the train obtained in each obtaining cycle of the data frame, where n is a quantity of obtaining cycles of the data frame.

In an embodiment, the obtained data frame is saved to the list location_list[n], so that the data in the list can be quickly found and compared, to facilitate the subsequent calculation of the location of the train when the train passes the balise.

In an embodiment, S30 includes the following sub-steps.

S310: The VOBC determines, based on a time difference between a receiving time of the response frame and an obtaining time of the data frame, a time t_balise when the train passes the balise.

S320: The VOBC calculates, based on the time t_balise when the train passes the balise and the saved list location_list [n], the location of the train when the train passes the balise.

In an embodiment, the time t_balise when the train passes the balise is calculated through the balise ID and the energy mark parameter transmitted by the BTM, and the time difference recorded by the FPGA in the VOBC. Further, the location of the train when the train passes the balise is calculated based on the saved list location_list [n], and then the location of the train is accurately calibrated.

In an embodiment, S310 includes the following sub-steps.

S311: The VOBC searches the periodically received response frames for a receiving time t_r of the current response frame based on an obtaining time ti of the current data frame, where t_r=ti−t_di. A minimum time difference exists between the receiving time t_r of the current response frame and the obtaining time ti of the current data frame. i∈[1, 2, . . . , N], and t_di is the minimum time difference between the obtaining time ti of the current data frame and the receiving time t_r of the current data frame.

S312: A transmission time t_s of the current response frame of the response frame transmitted by the BTM to the VOBC is determined based on the receiving time t_r of the current response frame, where t_s=t_r−t_delay. t_delay is a serial port data transmission delay from transmitting of the response frame by the BTM to receiving by the VOBC, which is 5 ms by experimental statistics.

S313: A transmission time t_o of a first response frame after the train passes the balise is determined based on the transmission time t_s of the current response frame.

Step S313 includes the following sub-steps.

S3130: A response frame transmission cycle interval m between the transmission of the current response frame and the transmission of the first response frame by the BTM is determined based on an energy mark parameter E_{b} in the current response frame and an energy mark parameter Eₐ in the first response frame, where m=|E_{b}−Eₐ|/ω, and ω is a preset interval.

S3131: The transmission time t_o of the first response frame is determined based on the transmission time t_s of the current response frame, the response frame transmission cycle interval m, and the transmission cycle t_b of the response frame, where t_o=t_s−m(t_b).

S314: It is determined, based on the transmission time t_o of the first response frame and a time interval t_d between the train passing the balise and the train transmitting the first response frame, that the time t_balise when the train passes the balise is

$$\begin{matrix}t\_balise = t\_o - t\_d \\ = t\_s - m ( t\_b ) - t\_d \\ = t\_r - t\_delay - m ( t\_b ) - t\_d \\ = ti - t\_di - t\_delay - m ( t\_b ) - t\_d .\end{matrix}$$

In an embodiment, timing is started when the BTM determines the location of the train passing the balise. After the train passes the balise, the BTM transmits the first response frame to the VOBC after a fixed time t_d.

As shown in FIG. 3, when the VOBC receives the energy mark parameter of 0 of the balise, the calculation method of the time t_balise when the train passes the balise is as follows:

$$t\_balise = t 2 - ( t\_d 2 ) - ( t\_d ) - t\_delay$$

where t_d2 is a time difference between the obtaining time t2 of the current data frame of the VOBC and a receiving time of the most recent response frame.

As shown in FIG. 3, when the VOBC receives the energy mark parameter of 3 of the balise, the calculation method of the time t_balise when the train passes the balise is as follows:

$$t\_balise = t 4 - ( t\_d 4 ) - ( 3 * t\_b ) - t\_delay - ( t\_d )$$

where t_d2 is a time difference between the obtaining time t4 of the current data frame of the VOBC and the receiving time of the most recent response frame.

When the VOBC receives an energy mark parameter of another value, the time t_balise when the train passes the balise may be calculated similarly.

In an embodiment, step S320 includes the following sub-steps.

S321: The time t_balise when the train passes the balise is compared with each current traveling time of the train in the list location_list[n] one by one, the list location_list[n] is searched for a time tn with a smallest time difference from the time t_balise, and an absolute value of the time difference is denoted as Δt.

S322: A location s_balise of the train when the train passes the balise is determined based on the time difference Δt and the current traveling speed vn and the current traveling distance sn of the train corresponding to the time tn.

In this embodiment, the location s_balise of the train when the train passes the balise is determined by searching the saved list location_list [n] for a closest time relative to the time t_balise when the train passes the balise. In this way, the calculation of the location s_balise is more accurate.

In an embodiment, step S322 includes:
determining the location of the train when the train passes the balise s_balise=sn−(Δt×vn) if tn>t_balise; and
determining the location of the train when the train passes the balise s_balise=sn+(Δt×vn) if tn<t_balise.

In this embodiment, the train is positioned based on information about the location s_balise when the train passes the balise that is calculated by the VOBC and identification information of the balise, which has high positioning accuracy.

In an embodiment, the BTM is an American standard BTM.

A European standard BTM-balise in the related art has high costs, a reader and the balise of the BTM are both expensive, and the balise has a relatively large volume, which has a high requirement for a track mounting space. The train positioning method of the present disclosure is also applicable to an American standard BTM-balise. The American standard BTM-balise and the BTM have low costs, and the volume of the American standard BTM-balise is much smaller than that of the European standard BTM-balise, which is convenient for site installation. In addition, the American standard BTM-balise can adapt to the light installation of the SkyShuttle line and reduce hardware costs, so as to accurately location the train.

It should be noted that although the operations of the method in the present disclosure are described in an order in the accompanying drawings, this does not require or imply that the operations are bound to be performed in the order, or all the operations shown are bound to be performed to achieve the desired result. On the contrary, the execution order of the steps depicted in the flowchart may be changed. For example, S102 may be first performed, and then S101 is performed.

FIG. 4 is a schematic structural diagram of a train positioning system according to an embodiment of the present disclosure.

As shown in FIG. 4, in another aspect, an embodiment of the present disclosure provides a train positioning system 400, a BTM 410, and a VOBC 420.

The BTM 410 is configured to periodically transmit balise data to the VOBC 420 according to a preset rule. The balise data includes identification information of a balise.

The VOBC 420 is further configured to periodically receive the balise data transmitted by the BTM 410, and periodically obtain a data frame. The data frame includes a current traveling time, a current traveling speed, and a current traveling distance of a train.

The VOBC 420 is further configured to determine, based on the received balise data and the obtained data frame, a location of the train when the train passes a central point of the balise.

In an embodiment, in this embodiment, information exchange may be performed between the BTM 410 and the balise and the VOBC 420. The BTM 410 includes a BTM host and a receiving antenna. The BTM 410 and the VOBC 420 are mounted to the train, and the balise is mounted to a track where the train runs. The VOBC 420 does not need to transmit information to the BTM 410. The BTM 410 host periodically transmits the balise data to the VOBC 420. The transmission of the balise data does not rely on any input of the VOBC 420. In some embodiments, the location of the balise is calculated by the VOBC, which improves reliability, reduces transmission errors caused by interference, and reduces a probability of a positioning failure of the balise. As shown in FIG. 2 and FIG. 3, the VOBC 420 includes VOBC_FPGA (a secure computer platform) and VOBC_APP (an ATP application). The BTM is communicatively connected with the VOBC_FPGA through a serial port 485. The BTM is configured to periodically transmit balise data to the VOBC_FPGA according to a preset rule. The balise data includes the identification information of the balise. The VOBC_APP periodically obtains and transmits the data frame to the VOBC_FPGA. The data frame includes the current traveling time, the current traveling speed, and the current traveling distance of the train. The VOBC_FPGA determines, based on the received balise data and the obtained data frame, a location of the train when the train passes a central point of the balise.

In an embodiment, referring to FIG. 4, the BTM 410 includes: an idle frame transmission module 412, configured to periodically transmit balise data that includes an idle frame to the VOBC if the BTM has not detected the balise; and a response frame transmission module 411, configured to periodically transmit balise data that includes a response frame to the VOBC if the BTM has detected the balise, the response frame including identification information and an energy mark parameter of the balise.

In an embodiment, the response frame transmission module 411 is further configured to successively increase or decrease the energy mark parameter based on a preset interval, as a number of transmission cycles of the response frame among the response frames periodically transmitted to the VOBC 420 increases after signal energy of the balise detected by the BTM 410 reaches a peak value.

In an embodiment, referring to FIG. 4, the VOBC 420 includes:
a response frame receiving module 421, configured to periodically receive the response frame transmitted by the response frame transmission module 411;
a data frame obtaining module 422, configured to periodically obtain a data frame, the data frame including a current traveling time, a current traveling speed, and a current traveling distance of a train; and
a central point determination module 423, configured to determine a location of the train when the train passes a central point of the balise based on the response frame received by the response frame receiving module 421 and the data frame obtained by the data frame obtaining module 422.

In an embodiment, referring to FIG. 4, the VOBC further includes a list saving module 424, configured to save the data frame obtained by the data frame obtaining module 422 to a list location_list [n].

In an embodiment, referring to FIG. 4, the central point determination module 423 includes:
a central point time determination unit 4231, configured to determine a time t_balise when the train passing the balise based on a time difference between a receiving time of the response frame obtained by the response frame receiving module 421 and an obtaining time of the data frame obtained by the data frame obtaining module 422; and
a central point location determination unit 4232, configured to determine a location of the train when the train passes the balise based on the time t_balise when the train passes the balise that is determined by the central point time determination unit 4231 and the list location_list [n] saved by the list saving module 424.

In an embodiment, the central point time determination unit 4231 is further configured to:
search, based on an obtaining time ti of a current data frame obtained by the data frame obtaining module 422, the response frame periodically received by the response frame receiving module 421 for a closest receiving time t_r=ti−t_di of a current response frame relative to the obtaining time ti of the current data frame, i∈[1, 2, . . . , n], n being a quantity of obtaining cycles of the data frame, and t_di being the minimum time difference between the obtaining time ti of the current data frame and the receiving time t_r of the current data frame;
determine, based on the receiving time t_r of the current response frame, a transmission time of the current response frame of the response frame transmitted by the response frame transmission module 411 to the response frame receiving module 421 t_s=t_r−t_delay, t_delay being a serial port data transmission delay from transmitting of the response frame by the response frame transmission module to receiving by the response frame receiving module;
determine a transmission time t_o of a first response frame after the train passes the balise based on the transmission time t_s of the current response frame; and determine, based on the transmission time to of the first response frame and a time interval t_d between the time the train passes the balise and the transmission time of the first response frame, a time when the train passes the balise t_balise=t_o−t_d.

In an embodiment, the central point time determination unit 4231 is further configured to:
determine a response frame transmission cycle interval m between transmission of the current response frame and transmission of the first response frame based on an energy mark parameter in the current response frame and an energy mark parameter in the first response frame; and
determine the transmission time t_o of the first response frame based on the transmission time t_s of the current response frame, the response frame transmission cycle interval m, and the transmission cycle t_b of the response frame, where t_o=t_s−m(t_b).

In an embodiment, the central point location determination unit 4232 is further configured to:
compare the time t_balise when the train passes the balise that is determined by the central point time determination unit 4231 with the current traveling time of the train in the list location_list[n] saved in the list saving module 424 one by one, search the list location_list[n] for a time tn with a smallest time difference from the time t_balise, and denote an absolute value of the time difference as Δt; and
determine, based on the time difference Δt and the current traveling speed vn and the current traveling distance sn of the train corresponding to the time tn, a location s_balise of the train when the train passes the balise, which includes the following steps:
determining the location of the train when the train passes the balise s_balise=sn−(Δt×vn) if tn>t_balise; and
determining the location of the train when the train passes the balise s_balise=sn+(Δt×vn) if tn<t_balise.

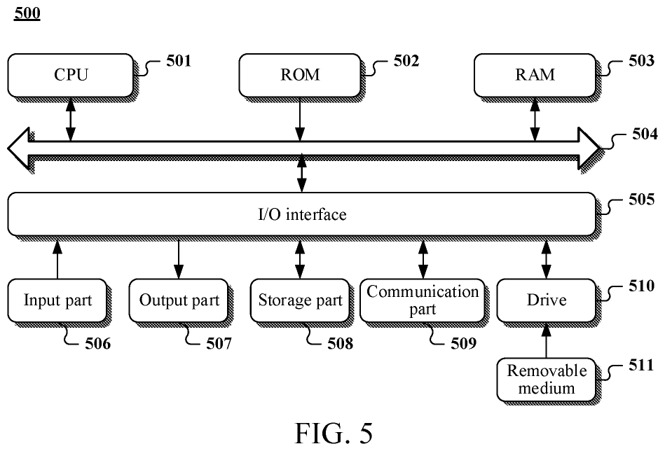

FIG. 5 is a schematic structural diagram of a vehicle on-board device according to an embodiment of the present disclosure.

As shown in FIG. 5, in another aspect, the present disclosure further provides a vehicle on-board device 500, including one or more central processing units (CPUs) 501, which may perform various appropriate actions and processing based on a program stored in a read-only memory (ROM) 502 or a program loaded into a random access memory (RAM) 503 from a storage part 508. The RAM 503 further stores various programs and data required for system operations. The CPU 501, the ROM 502, and the RAM 503 are connected to each other through a bus 504. An input/output (I/O) interface 505 is also connected to the bus 504.

The following components are connected to the I/O interface 505, for example, input parts 506 including a keyboard and a mouse; output parts 507 including a cathode ray tube (CRT), a liquid crystal display (LCD), a loudspeaker, and the like; the storage part 508 including a hard disk, and the like; and a communication part 509 including a network interface card such as a LAN card or a modem. The communication part 509 performs communication processing by using a network such as the Internet. A drive 510 is also connected to the I/O interface 505 as required. A removable medium 511 such as a magnetic disk, an optical disk, a magneto-optical disk, or a semiconductor memory is installed on the drive 510 as required, so that a computer program read from the removable medium is installed into the storage part 508 as required.

Particularly, according to the embodiment of the present disclosure, the processes described above with reference to FIG. 2 and FIG. 3 may be implemented as a computer software program. For example, an embodiment of the present disclosure includes a computer program product, which includes a computer program tangibly included in a machine-readable medium. The computer program includes program code for performing a train positioning method. In such an embodiment, the computer program may be downloaded from a network through the communication part 509 and installed, and/or installed from the removable medium 511.

Flowcharts and block diagrams in the accompanying drawings illustrate system architectures, functions, and operations that may be implemented by using the system, the method, and the computer program product according to the various embodiments of the present disclosure. In this regard, each block in the flowchart or the block diagram may represent a module, a program segment, or part of code. The module, the program segment, or the part of the code includes one or more executable instructions for implementing specified logical functions. It should also be noted that, in some alternative implementations, functions labeled in the blocks may also be executed in a different order from those labeled in the accompanying drawings. For example, two boxes shown in succession may be performed basically in parallel, and sometimes the two boxes may be performed in a reverse order. This depends on the function involved. It is also to be noted that each block of the block diagrams and/or flowcharts and combinations of blocks in the block diagrams and/or flowcharts may be implemented by dedicated hardware-based systems that execute the specified functions or operations, or may be implemented in a combination of dedicated hardware and computer instructions.

In still another aspect, the present disclosure further provides a non-transitory computer-readable storage medium. The non-transitory computer-readable storage medium may be a computer-readable storage medium included in the apparatuses in the foregoing embodiments, or may be a computer-readable storage medium that exists alone and is not assembled into a device. The non-transitory computer-readable storage medium stores one or more programs. The programs are used by one or more processors to perform the train positioning method described in the present disclosure.

Flowcharts and block diagrams in the accompanying drawings illustrate system architectures, functions, and operations that may be implemented by using the system, the method, and the computer program product according to the various embodiments of the present disclosure. In this regard, each block in the flowchart or the block diagram may represent a module, a program segment, or part of code. The module, the program segment, or the part of the code includes one or more executable instructions for implementing specified logical functions. It should also be noted that, in some alternative implementations, functions labeled in the blocks may also be executed in a different order from those labeled in the accompanying drawings. For example, two boxes shown in succession may be performed basically in parallel, and sometimes the two boxes may be performed in a reverse order. This depends on the function involved. It is also to be noted that each block of the block diagrams and/or flowcharts and combinations of blocks in the block diagrams and/or flowcharts may be implemented by dedicated hardware-based systems that execute the specified functions or operations, or may be implemented in a combination of dedicated hardware and computer instructions.

The modules described in the embodiments of the present disclosure may be implemented by software or hardware. The described modules may be arranged in a processor. For example, each of the modules may be a software program installed in a computer or a mobile smart device, or may be a separately configured hardware apparatus. In some cases, the modules or names of the modules do not constitute a limitation on the module.

The above descriptions are merely preferred embodiments of the present disclosure and explanation of the technical principles that are used. A person skilled in the art should understand that the scope of the present disclosure is not limited to the technical solutions formed by the combination of the above technical features, but should also cover other technical solutions formed by any combination of the above technical features or their equivalent features without departing from the concept of the present disclosure. For example, the above features are mutually replaced with (but not limited to) technical features with similar functions disclosed in the present disclosure.

What is claimed is:

1. A method for train positioning, comprising:
periodically transmitting, by a balise transmission module (BTM), balise data to a vehicle on-board controller (VOBC) according to a rule;
periodically receiving, by the VOBC, the balise data transmitted by the BTM, and periodically obtaining a data frame, the data frame comprising a current traveling time tn, a current traveling speed vn, and a current traveling distance sn of a train; and
determining, by the VOBC based on the received balise data and the obtained data frame, a location of the train when the train passes a balise.

2. The method according to claim 1, wherein the periodically transmitting, by the BTM, the balise data to the VOBC according to the rule comprises:
in response to that the BTM does not detect the balise, periodically transmitting the balise data comprising an idle frame to the VOBC; and
in response to that the BTM detects the balise, periodically transmitting the balise data comprising a response frame to the VOBC, and the response frame comprising identification information and an energy mark parameter of the balise.

3. The method according to claim 2, wherein in response to that the BTM detects the balise, periodically transmitting the balise data comprising the response frame to the VOBC comprises:
successively increasing or decreasing the energy mark parameter of the balise after a signal strength detected by the BTM reaches a peak value.

4. The method according to claim 1, wherein the periodically obtaining the data frame comprises:
saving the data frame to a list location_list [n], wherein the list location_list[n] comprises a current traveling time, a current traveling speed, and a current traveling distance of the train in each data-frame obtaining cycle, and n is a number of data-frame obtaining cycles.

5. The method according to claim 4, wherein the determining, by the VOBC based on the received balise data and the obtained data frame, the location of the train when the train passes the balise comprises:
determining, by the VOBC based on a time difference between a receiving time of the response frame and an obtaining time of the data frame, a time t_balise when the train passes the balise; and
calculating, by the VOBC based on the time t_balise and the saved list location_list [n], the location of the train when the train passes the balise.

6. The method according to claim 5, wherein the determining, by the VOBC based on the time difference between the receiving time of the response frame and the obtaining time of the data frame, the time t_balise when the train passes the balise comprises:
searching, by the VOBC, the periodically received response frames for a receiving time t_r of a current response frame based on an obtaining time ti of a current data frame, a minimum time difference t_di between the receiving time t_r of the current response frame and the obtaining time ti of the current data frame, i∈[1, 2, . . . , n], wherein t_r=ti−t_di;
determining a transmission time t_s of the current response frame of the response frame transmitted by the BTM to the VOBC based on the receiving time t_r of the current response frame and a serial port data transmission delay t_delay from transmitting of the response frame by the BTM to being received by the VOBC, where t_s=t_r−t_delay;
determining a transmission time t_o of a first response frame after the train passes the balise based on the transmission time t_s of the current response frame; and
determining, based on the transmission time t_o of the first response frame and a time interval t_d between the time t_balise when the train passes the balise and the transmission time t_o of the first response frame, where t_balise=t_o−t_d.

7. The method according to claim 6, wherein the determining the transmission time t_o of the first response frame after the train passes the balise based on the transmission time t_s of the current response frame, comprises:
determining, based on an energy mark parameter E_{b} in the current response frame and an energy mark parameter Eₐ in the first response frame, a response frame transmission cycle interval m=|E_{b}−Eₐ|/ω between a transmission of the current response frame and a transmission of the first response frame, ω being an interval; and
determining the transmission time t_o of the first response frame based on the transmission time t_s of the current response frame, the response frame transmission cycle interval m, and a transmission cycle t_b of the response frame, where t_o=t_s−m(t_b).

8. The method according to claim 7, wherein t_balise=ti−t_di−m(t_b)−t_d−t_delay.

9. The method according to claim 5, wherein the calculating, by the VOBC based on the time t_balise and the saved list location_list [n], the location of the train when the train passes the balise comprises:
obtaining a time difference between the time t_balise and each current traveling time of the train in the list location_list[n], searching the list location_list[n] for a current traveling time tn corresponding to a smallest time difference, and denoting an absolute value of the smallest time difference as Δt; and
determining, based on the smallest time difference and a current traveling speed vn and a current traveling distance sn of the train corresponding to the current traveling time tn, a location s_balise of the train when the train passes the balise.

10. The method according to claim 9, wherein the determining, based on the smallest time difference and the current traveling speed vn and the current traveling distance sn of the train corresponding to the current traveling time tn, the location s_balise of the train when the train passes the balise comprises:
if tn>t_balise, determining the location s_balise=sn−(Δt×vn) of the train when the train passes the balise; and
if tn<t_balise, determining the location s_balise=sn+(Δt×vn) of the train when the train passes the balise.

11. A system for train positioning, comprising a balise transmission module (BTM) and a vehicle on-board controller (VOBC), wherein
the BTM is configured to periodically transmit balise data to the VOBC according to a rule, and the balise data comprises identification information of a balise;
the VOBC is configured to periodically receive the balise data transmitted by the BTM, and periodically obtain a data frame, and the data frame comprises a current traveling time tn, a current traveling speed vn, and a current traveling distance sn of a train; and
the VOBC is configured to determine, based on the received balise data and the obtained data frame, a location of the train when the train passes the balise.

12. The system according to claim 11, wherein the BTM is further configured to:
in response to that the BTM does not detect the balise, periodically transmit the balise data comprising an idle frame to the VOBC; and
in response to that the BTM detects the balise, periodically transmit the balise data comprising a response frame to the VOBC, the response frame comprising identification information and an energy mark parameter of the balise.

13. The system according to claim 12, wherein the BTM is further configured to:
in response to that the BTM detects the balise, successively increase or decrease the energy mark parameter of the balise after a signal strength detected by the BTM reaches a peak value.

14. The system according to claim 11, wherein the VOBC is further configured to:
save the data frame to a list location_list [n], wherein the list location_list[n] comprises a current traveling time, a current traveling speed, and a current traveling distance of the train in each data-frame obtaining cycle, and n is a number of data-frame obtaining cycles.

15. The system according to claim 14, wherein the VOBC is further configured to:
determine, based on a time difference between a receiving time of the response frame and an obtaining time of the data frame, a time t_balise when the train passes the balise; and
calculate, based on the time t_balise and the saved list location_list [n], the location of the train when the train passes the balise.

16. The system according to claim 15, wherein the VOBC is further configured to:
searching, by the VOBC, the periodically received response frames for a receiving time t_r of a current response frame based on an obtaining time ti of a current data frame, a minimum time difference t_di between the receiving time t_r of the current response frame and the obtaining time ti of the current data frame, i∈[1, 2, . . . , n], wherein t_r=ti−t_di;
determining a transmission time t_s of the current response frame of the response frame transmitted by the BTM to the VOBC based on the receiving time t_r of the current response frame and a serial port data transmission delay t_delay from transmitting of the response frame by the BTM to being received by the VOBC, where t_s=t_r−t_delay;
determining a transmission time t_o of a first response frame after the train passes the balise based on the transmission time t_s of the current response frame; and
determining, based on the transmission time t_o of the first response frame and a time interval t_d between the time t_balise when the train passes the balise and the transmission time t_o of the first response frame, where t_balise=t_o−t_d.

17. The system according to claim 16, wherein the VOBC is further configured to:
determine, based on an energy mark parameter E_{b} in the current response frame and an energy mark parameter Eₐ in the first response frame, a response frame transmission cycle interval m=|E_{b}−Eₐ|/ω between a transmission of the current response frame and a transmission of the first response frame, ω being an interval; and
determine the transmission time t_o of the first response frame based on the transmission time t_s of the current response frame, the response frame transmission cycle interval m, and a transmission cycle t_b of the response frame, where t_o=t_s−m(t_b).

18. The system according to claim 17, wherein t_balise=ti−t_di−m(t_b)−t_d−t_delay.

19. The system according to claim 15, wherein the VOBC is further configured to:
obtain a time difference between the time t_balise and each current traveling time of the train in the list location_list[n], search the list location_list[n] for a current traveling time tn corresponding to a smallest time difference, and denote an absolute value of the smallest time difference as Δt; and
determine, based on the smallest time difference and a current traveling speed vn and a current traveling distance sn of the train corresponding to the current traveling time tn, a location s_balise of the train when the train passes the balise.

20. The system according to claim 19, wherein the VOBC is further configured to:
if tn>t_balise, determining the location s_balise=sn−(Δt×vn) of the train when the train passes the balise; and
if tn<t_balise, determining the location s_balise=sn+(Δt×vn) of the train when the train passes the balise.
